(19) United States
(12) Patent Application Publication
(10) Pub. No.: US 2005/0204875 A1
(43) Pub. Date: Sep. 22, 2005

(54) Anti-tamper fastener

(76) Inventor: Robert Schluter, Tavernier, FL (US)

Correspondence Address: Robert E. Cannuscio;Drinker Biddle & Reath LLP, One Logan Square, 18th & Cherry Streets, Philadelphia, PA, 19103-6996, US

(21) Appl. No.: 10/980,599

(22) Filed: Nov. 3, 2004

Related U.S. Application Data
(60) Provisional application No. 60/554,878, filed on Mar. 19, 2004.

(51) Int. Cl. B25B 15/00

(52) U.S. Cl. 81/436

(57) ABSTRACT

An anti-tamper fastener with a fastener head with a first side and a second side and a shank attached to and extending out from the second side. The fastener head has a substantially square hole formed in the first side that extends into the fastener head to a base. A post is located in the hole and extends out from the base toward the first side. A driver is also disclosed which is shaped to mate with the fastener. The driver includes a substantially square shank portion with a hole formed in it. The shank portion is sized to fit within the square hole in the fastener and the hole sized to receive the post in the fastener.

### RELATED APPLICATION

This application is related to and claims priority from U.S. Provisional Patent Application Ser. No. 60/554,878 filed Mar. 19, 2004, the entire disclosure of which is incorporated herein by reference in its entirety.

### FIELD OF THE INVENTION

The present invention relates to fasteners and, more particularly, to an anti-tamper fastener, with a unique engagement slot which requires a unique mating tool for removal.

### BACKGROUND

There are many fasteners in the marketplace for use in attaching components together. Most of those fasteners are installed using widely available conventional drivers, such as a slotted driver or a Phillips head driver. As such these fasteners can be installed and removed by anyone using readily available tools.

In recent years, unique anti-tamper fasteners have been developed that require the use of specific shaped drivers. These have been designed to inhibit removal of the fastener without the special driver. One such fastener is sold under the trademark TORX, Plus® by Textron Fastening Systems. The fastener includes a multi-lobed opening with a center post. The center post is designed to inhibit insertion of a conventional driver into the opening.

While the TORX Plus fastener provides some degree of anti-tamper protection by inhibiting conventional drivers from being used to remove the fastener, the multi-lobe design provides limited torque capability. As such, there is a tendency of the driver to cam-out upon the application of very low torque. This limits the use of the fastener to low torque applications.

A need, therefore, exists for an improved anti-tamper fastener which provides increased cam-out torque.

### SUMMARY OF THE INVENTION

An anti-tamper fastener with a fastener head with a first side and a second side and a shank attached to and extending out from the second side. The fastener head has a substantially square hole formed in the first side that extends into the fastener head to a base. A post is located in the hole and extends out from the base toward the first side.

A driver is also disclosed which is shaped to mate with the fastener. The driver includes a substantially square shank portion with a hole formed in it. The shank portion is sized to fit within the square hole in the fastener and the hole sized to receive the post in the fastener.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention. Accordingly, the drawings and the description are to be regarded as illustrative in nature, and not as restrictive.

### BRIEF DESCRIPTION OF THE DRAWINGS

For the purpose of illustrating the invention, the drawings show a form of the invention which is presently preferred. However, it should be understood that this invention is not limited to the precise arrangements and instrumentalities shown in the drawings.

FIG. 1 is an isometric view of an anti-tamper fastener according to one embodiment of the present invention.

FIG. 2 is a side view of the fastener of FIG. 1.

FIG. 3 is a top view of the fastener of FIG. 1.

FIG. 4 is a bottom view of the fastener of FIG. 1.

FIG. 5 is a particle sectional view of the fastener of FIG. 1.

FIG. 6 is an isometric view of a second embodiment of an anti-tamper fastener according to the present invention.

FIG. 7 is an isometric view of a driver for use with an anti-tamper fastener according to the present invention.

FIG. 8 is a side view of the driver of FIG. 7.

FIG. 9 is a front view of the driver of FIG. 7.

FIG. 10 is a top view of the driver of FIG. 7.

FIG. 11 is a bottom view of the driver of FIG. 7.

FIG. 12 is an isometric view of a second embodiment of a driver for use with an anti-tamper fastener according to the present invention.

### DETAILED DESCRIPTION OF THE PREFERRED EMBODIMENTS

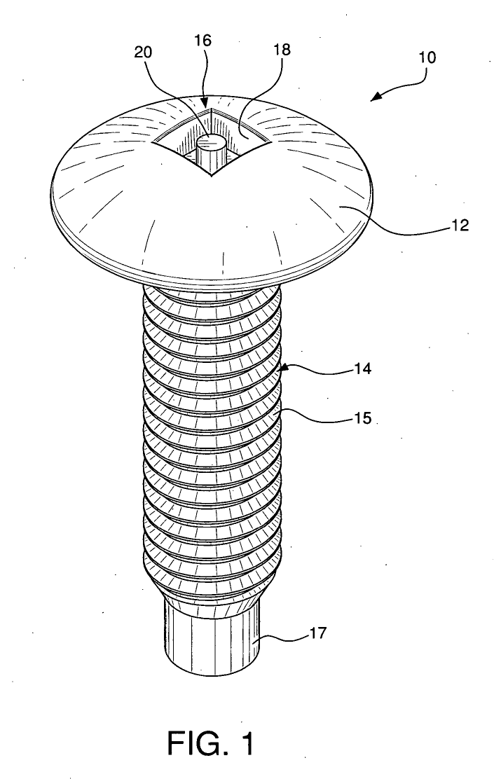

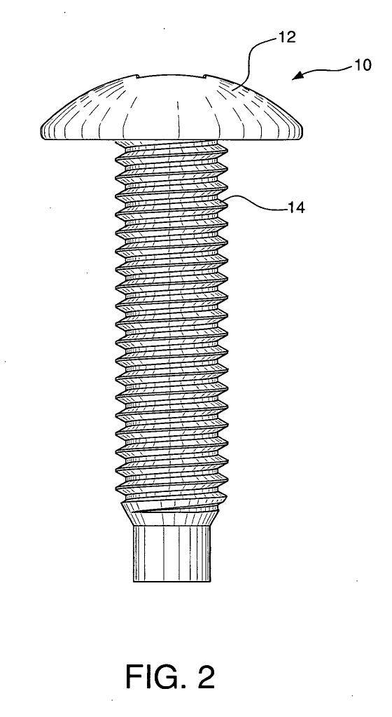

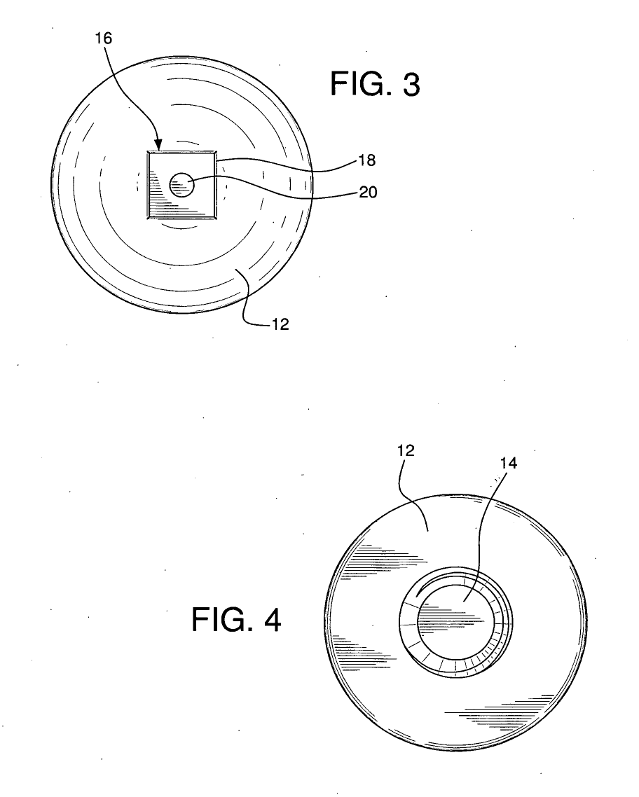

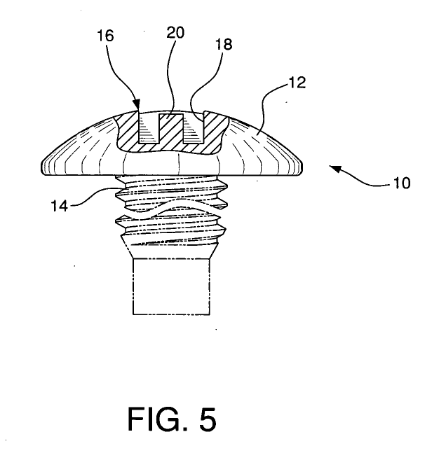

Referring now to the drawings, wherein like reference numerals refer to similar components throughout the views, several embodiments of the invention are shown which are currently preferred. FIGS. 1-5 illustrate an isometric view of a fastener 10 according to one embodiment of the present invention. The fastener 10 includes a head 12 which in the illustrated embodiment is a fillister head. However, any fastener head 12 can be used without departing from the scope of the invention. The fastener also includes a shank 14 which is formed on one side of the fastener head 12. The shank 14 is preferably cylindrical in shape, although other shapes are possibly, such as a tapered conical shape. A set of conventional threads 15, such as 10-32 UNF, 10-24 UNF, 5 mm or 6 mm threads, are formed about at least a portion of the shank. The shank 14 includes a tip end 17, which may be threaded or include a dog point as shown.

The fastener 10 includes a fastener recess 16 formed in the fastener head 12. The fastener recess 16 includes a substantially square aperture or slot 18. Preferably the aperture has an opening that is either a #2 or #3 square recess. Alternatively, the aperture preferably has sides with a width at the top that is between about 0.100 inches to about 0.140 inches. The present invention is not limited to these sizes, however and, thus, encompasses various other size openings. The recess 16 also has a depth that is sized to provide a sufficient bearing surface for applying torque to the fastener. In one preferred embodiment, the depth is between about 0.052 inches to about 0.062 inches. It should be readily apparent that the depth of the recess can be varied depending on the size of the head 12 and the size of the opening 18. The walls 18 of the recess 16 preferably taper inward approximately at an angel less than five degrees and more preferably at an angle of about 2 degrees to 3 degrees. Thus, for a #2 size square recess, the taper would be from approximately 0.123 inches at the outer edge to about 0.112 inches at the base.

The fastener recess 16 also includes a center post 20 which is formed in the base 20 and protrudes upward toward the outer end 21. The center post 20 is formed integral with the head 12 and is designed to operate in combination with the square opening to inhibit tampering of the fastener. More particularly, the inclusion of the post 20 prevents a convention square driver, as well as most conventional flat drivers, from being inserted into the recess 16. In one embodiment of the invention, for a fastener with a #2 square opening, the center post 20 has a diameter that is between about 0.030 inches and about 0.050 inches. For a fastener with a #3 square opening, the center post 20 has a diameter that is between about 0.030 inches and about 0.080 inches. These post sizes are designed to limit the space between the post and the corners of the square opening, thus inhibiting insertion of most conventional drivers. It should be readily apparent that the diameter of the center post can vary depending on the size of the opening 18.

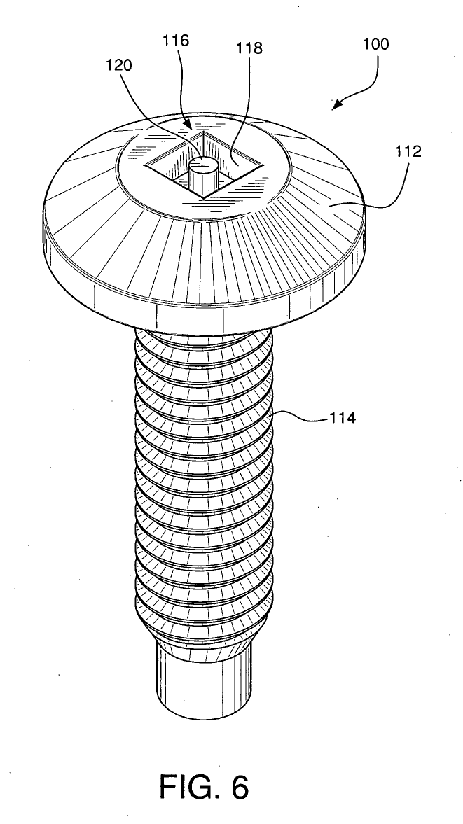

FIG. 6 illustrates an alternate embodiment 100 of a fastener according to the present invention. In this embodiment, the fastener 100 includes a button or pan head 112. The fastener 110 also includes a shank 114 and recess 116 as discussed above. The recess has a substantially square opening 118 and a center port 120.

The fastener of the present invention can be made from any convention material used to make fasteners, such as metal (e.g., steel or zinc), plastic or composite.

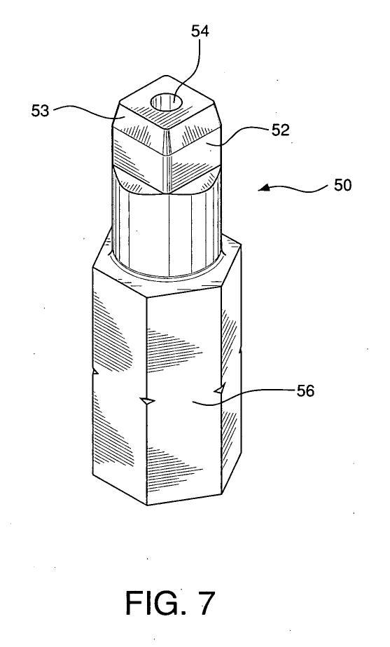

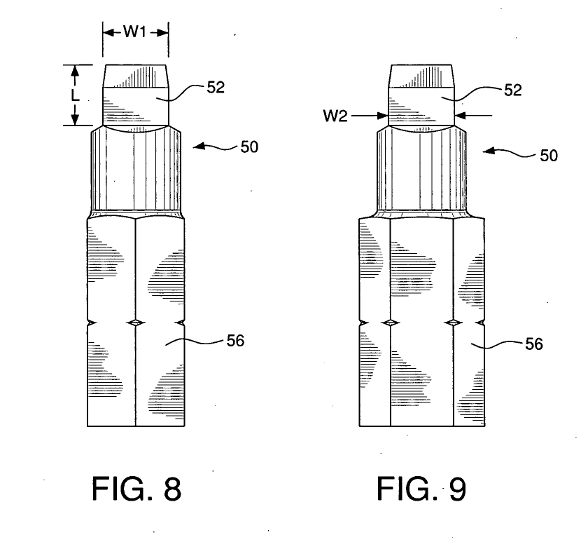

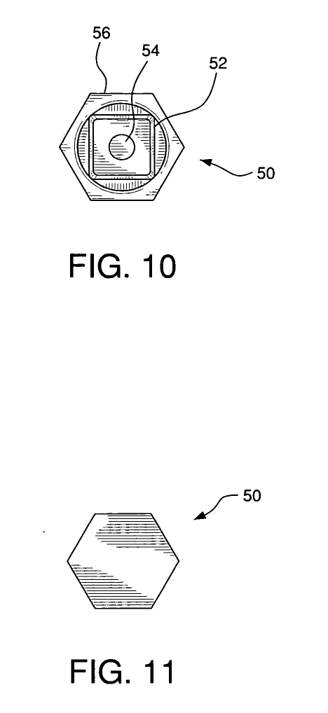

In order to attach and remove the fastener 10 to/from a structure, the present invention contemplates use of a unique driver 50. Referring now to FIGS. 7-11, one embodiment of a driver 50 according to the present invention is illustrated. In this embodiment, the driver 50 is a driver bit that is used in combination with a conventional screw or ratchet drive. The driver 50 includes a square shank portion 52. The dimensions of the shank 52 are preferably slightly smaller than the shape of the aperture of the fastener recess 16 so that the shank 52 will fit into the recess while at the same time producing a snug fit such that the fastener is held on the driver 50 during installation. For example, for a #2 size hole, the shank 52 preferably has a width W1 of approximately 0.109 inches near its top and preferably has a length L of at least about 0.144 inches. The wall of the shank preferably tapers outwardly to a width W2 of approximately 0.122 at the base of the square section. This is approximately a 2 degree to 3 degree outward taper, thus corresponding to the taper of the wall of the recess 16. In one embodiment, wall tapers at an angle of approximately 92.6 degrees.

A hole 54 is formed down the center of the shank 52. The hole 54 is sized to receive the post 20 in the recess 16 of the fastener. The hole 54 preferably has a diameter of approximately 0.055 inches and a depth into the shank of at least about 0.115 inches.

It should be readily apparent that the dimensions of the shank 52 and hole 54 can be varied to accommodate different recesses.

A slight chamfer 53 may be formed near the tip of the shank portion 52 to facilitate insertion into the recess.

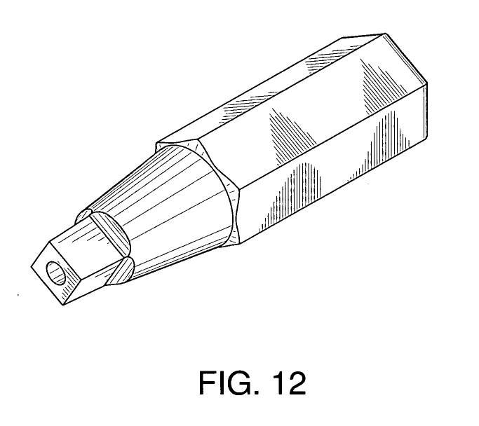

FIG. 12 illustrates a slightly different embodiment of the driver bit according to the present invention.

As shown in the figures and discussed above, the driver 50 is this embodiment is a drive bit. In order to engage with a convention screw or ratchet drive, the driver 50 includes a conventional shank base 56, such as a hexagonal shank base as shown. The shank base 56 would be sized to engage with convention screw drives and ratchet drives, such as ¼ or ½ inch drives. Other sizes are also possible.

It is also contemplated that the driver 50 may be formed as a key that includes a handle portion for grasping by a user. It is also contemplated that the driver may be part of a screwdriver and, thus, would include an enlarged handle that is attached to an elongated portion of the shank.

The combination of the center post and the square recess provide a tamper resistant mechanism for installing and removing the fastener. Conventional drivers are inhibited from engaging with the fastener due to the existence of the center post. Hence, the fastener can only be removed and installed through the use of the special driver described above.

Another benefit of the fastener configuration is its increased torque capability. A square aperture provides high cam out properties. The addition of the center post further enhances this by maintaining the driver centered within the recess, thus maximizing the transmission of torque to the fastener while inhibiting cocking of the driver as the fastener is installed or removed. In one embodiment of the invention, the configuration of the fastener is such that it can withstand torquing of at least about 8 ft-lbs.

While the figures illustrate a driver bit, it is also contemplated that the driver can be formed with a screw driver handle, or as part of a key. Also, while the drawings illustrate a pan head fastener, the present invention can be incorporated into any conventional fastener.

1. An anti-tamper fastener comprising:
a fastener head with a first side and a second side;
a shank attached to and extending out from the second side;
a substantially square hole formed in the first side and extending into the fastener head to a base; and
a post located in the hole and extending from the base toward the first side.

2. The anti-tamper fastener of claim 1, wherein the post is substantially cylindrical in shape.

3. The anti-tamper fastener of claim 1, wherein the hole tapers from the first surface to the base.

4. The anti-tamper fastener of claim 3, wherein the taper is between approximately 2 degrees and 3 degrees, and wherein the post is substantially cylindrical in shape.

5. The anti-tamper fastener of claim 3, wherein the taper is approximately 2.6 degrees.

6. The anti-tamper fastener of claim 2, wherein the post is located in substantially the center of the hole.

7. The anti-tamper fastener of claim 6, wherein the post has a diameter between about 0.030 inches and about 0.080 inches.

8. The anti-tamper fastener of claim 6, wherein the post has a diameter between about 0.030 inches and about 0.050 inches, and wherein the hole has side walls with a width at the first side between about 0.100 inches and about 0.140 inches.

9. The anti-tamper fastener of claim 6, wherein the hole has a depth between the first surface and the base between about 0.052 inches and about 0.062 inches.

10. The anti-tamper fastener of claim 8, wherein the hole is defined by side walls, and wherein the spacing between the post and the hole wall is less than 0.1114 inches.

11. The anti-tamper fastener of claim 6, wherein the shank has threads formed on at least a portion of it.

12. An anti-tamper fastener comprising:
a fastener head with a first side and a second side;
a shank attached to and extending out from the second side, the shank having threads formed on at least a portion of it;
a substantially square hole formed in the first side and extending into the fastener head to a base, the fastener hole having side walls that taper from the first side to the base; and
a substantially cylindrical post located in the hole and extending from the base toward the first side.

13. The anti-tamper fastener of claim 12, wherein the taper is between approximately 2 degrees and 3 degrees, and wherein the post is located in substantially the center of the hole.

14. The anti-tamper fastener of claim 13, wherein the taper is approximately 2.6 degrees.

15. The anti-tamper fastener of claim 13, wherein the post has a diameter between about 0.030 inches and about 0.080 inches.

16. The anti-tamper fastener of claim 13, wherein the post has a diameter between about 0.030 inches and about 0.050 inches, and wherein the hole side walls have a width at the first side between about 0.100 inches and about 0.140 inches.

17. The anti-tamper fastener of claim 16, wherein the hole has a depth between the first surface and the base between about 0.052 inches and about 0.062 inches.

18. The anti-tamper fastener of claim 12, wherein spacing between the post and the hole wall is less than 0.1114 inches.

19. The anti-tamper fastener of claim 12, wherein the fastener is part of a system including a removable driver for engaging with the hole in the fastener, the driver including a substantially square shank portion with a hole formed in it, the hole sized to receive the post and the shank portion sized to fit within the hole in the fastener.

20. An anti-tamper fastening system comprising:
an anti-tamper fastener comprising
a fastener head with a first side and a second side,
a shank attached to and extending out from the second side, the shank having threads formed on at least a portion of it,
a substantially square hole formed in the first side and extending into the fastener head to a base, the fastener hole having side walls that taper from the first side to the base, and
a substantially cylindrical post located in the hole and extending from the base toward the first side; and
a removable driver for engaging with the hole in the fastener, the driver comprising a substantially square shank portion with a hole formed in it, the hole sized to receive the post and the shank portion sized to fit within the hole in the fastener.

21. The anti-tamper fastening system of claim 20 wherein the driver shank portion has a top and wherein the width of the shank portion is approximately 0.109 inches near its top.

22. The anti-tamper fastening system of claim 20 wherein the driver shank portion has a top and wherein the width of the shank portion increase as the wall extends downward from the top.

23. The anti-tamper fastening system of claim 20 wherein the hole in the driver is located substantially in the center of the shank portion and is substantially cylindrical.

24. The anti-tamper fastening system of claim 23 wherein the hole has a diameter of approximately 0.055 inches and a depth into the shank of at least about 0.115 inches.

25. A driver for use with an anti-tamper fastener that has a square hole and the center post, the driver having a substantially square shank portion with a hole formed in it, the shank portion sized to fit within a square hole in the fastener and the hole sized to receive a post in the fastener.
